(19) United States
(12) Patent Application Publication
(10) Pub. No.: US 2006/0092091 A1
(43) Pub. Date: May 4, 2006

(54) Embedded antenna of mobile terminal

(75) Inventor: Young-Jin Kim, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/239,839

(22) Filed: Sep. 30, 2005

(30) Foreign Application Priority Data
Oct. 29, 2004 (KR) 87310/2004

(51) Int. Cl. H01Q 1/36

(52) U.S. Cl. 343/895

(57) ABSTRACT

An embedded antenna of a mobile terminal, which includes antennas having different resonance frequency characteristics, a feeding point connected to the antennas and used for feeding, and lines for connecting the antennas to the feeding point.

### PRIORITY

This application claims priority to an application entitled “Embedded Antenna of Mobile Terminal” filed in the Korean Intellectual Property Office on Oct. 29, 2004 and assigned Serial No. 2004-87310, the contents of which are incorporated herein by reference.

### BACKGROUND OF THE INVENTION

1. Field of the Invention

The present invention relates to an antenna, and more particularly to an embedded antenna of a mobile terminal.

2. Description of the Related Art

A current mobile communication system is rapidly developing various devices including a cellular phone, the personal communication service (PCS), the international mobile telecommunications (IMT)-2000, and the personal digital assistant (PDA). The scale of the mobile communication system market is rapidly enlarging as well. The IMT-2000 (3^{rd} generation mobile communication), which has been under recent active research and development, provides high speed data and multimedia service, as well as voice and low speed data, which are currently provided by the existing cellular phone and the existing PCS (2^{nd} and 2.5^{nd} generation, respectively). A small personal portable terminal with high performance is being studied with the growth of such various mobile communication systems. It is indispensable for such a small personal portable terminal to be equipped with a small embedded antenna for miniaturization.

Although most existing terminals employ external retractable antennas such as a monopole antenna and a helical antenna, the external retractable antennas have been pointed out as obstacles to miniaturization of the terminals. As small embedded antennas have been studied in order to overcome the obstacles, a planer inverted F antenna (PIFA) and a short-circuit microstrip antenna have been suggested.

FIG. 1A is a view showing an example of an embedded antenna in the conventional cellular phone and a structure of the PIFA. FIG. 1B is a view showing a location for incorporating an embedded antenna in the conventional cellular phone.

The PIFA includes a grounding surface, a patch, a feeding point 10, and a short plate or a short pin 20. The short pin or the short plate 20 connects the grounding surface to the patch, and the embedded antenna is fed through the feeding point 10 connected to the embedded antenna through the grounding surface. Since such a conventional embedded antenna has the grounding surface, the embedded antenna cannot be incorporated together with other components of the cellular phone and thus requires an area for incorporating the embedded antenna, which is provided. A dotted area shown in FIG. 1b represents the area for incorporating the embedded antenna.

However, there is a problem in that such a conventional embedded antenna has a narrow bandwidth. In order to widen the bandwidths of this PIFA and this short-circuit microstrip antenna, the size of the PIFA and the short-circuit microstrip antenna increase. The space for incorporating the embedded antennas also increases according to the size increase of the antenna. Therefore, the embedded antennas occupy a significant amount of the inner space of the cellular phone.

FIG. 2 is a view showing a helical antenna is incorporated in the conventional cellular phone. FIG. 3 is a graph showing return loss of the helical antenna in the conventional cellular phone.

Referring to FIG. 2, a helical antenna 50 is incorporated in the cellular phone. Herein, the helical antenna 50 occupies a small space in the cellular phone as shown in FIG. 2. Meanwhile, a meander line antenna has advantages similar to that of the helical antenna.

However, when the helical antenna or the meander line antenna is used as an embedded antenna, they have available bandwidths improper for the embedded antennas as shown in FIG. 3. Referring to FIG. 3, a solid curve shows a return loss characteristic of the helical antenna 50. In order for an antenna to stably operate in a cellular phone, the bandwidth of the antenna must have a characteristic shown by a dashed dot curve. In other words, the antenna must have at least a bandwidth indicated by reference numeral 70 under a return loss of −10 dB. However, since the helical antenna 50 has a bandwidth indicated by reference numeral 72 under a return loss of −10 dB, the helical antenna is improper for use as an embedded antenna in a cellular phone.

### SUMMARY OF THE INVENTION

Accordingly, the present invention has been made to solve the above-mentioned problems occurring in the prior art, and it is an object of the present invention to provide an embedded antenna having a wide bandwidth while occupying a small space within the terminal.

To accomplish the above object, there is provided an antenna apparatus including antennas having different resonance frequency characteristics, a feeding point connected to the antennas and used for feeding, and lines for connecting the antennas to the feeding point.

### BRIEF DESCRIPTION OF THE DRAWINGS

The above and other objects, features and advantages of the present invention will be more apparent from the following detailed description taken in conjunction with the accompanying drawings, in which:

FIG. 1A is a view showing an example of an embedded antenna in the conventional cellular phone;

FIG. 1B is a view showing a position for incorporating an embedded antenna in the conventional cellular phone;

FIG. 2 is a view showing a helical antenna incorporated in the conventional cellular phone;

FIG. 3 is a graph showing return loss of a helical antenna in the conventional cellular phone;

FIG. 4 is a view showing an antenna apparatus according to one embodiment of the present invention;

FIG. 5 is a view showing an structure in which an antenna apparatus is incorporated in a cellular phone;

FIG. 6 is a view showing an antenna apparatus according to another embodiment of the present invention;

FIG. 7A is a graph showing the individual resonance characteristics of two antennas in an antenna apparatus according to the present invention;

FIG. 7B is a graph showing the synthesis of resonance characteristics of two antennas in an antenna apparatus according to the present invention; and

FIG. 8 is a graph showing the performance of an antenna apparatus according to the present invention.

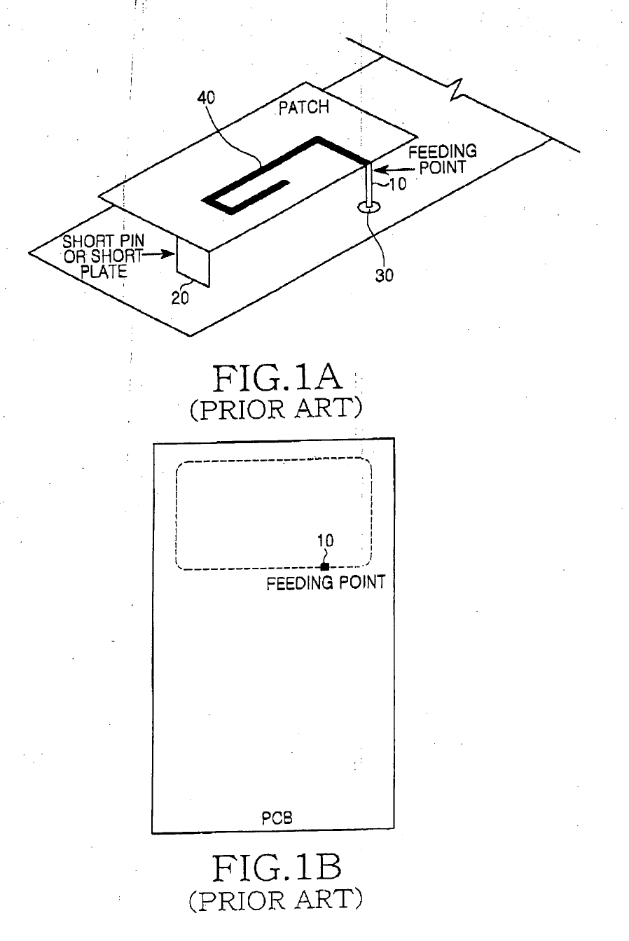

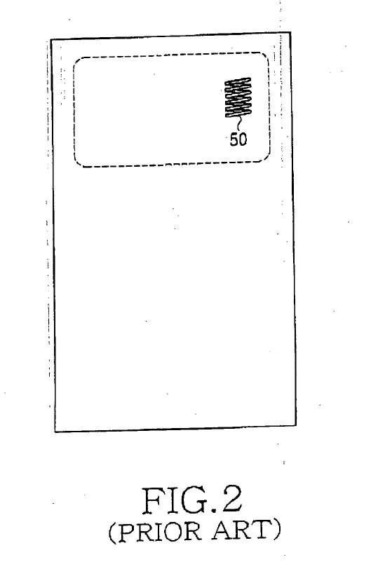

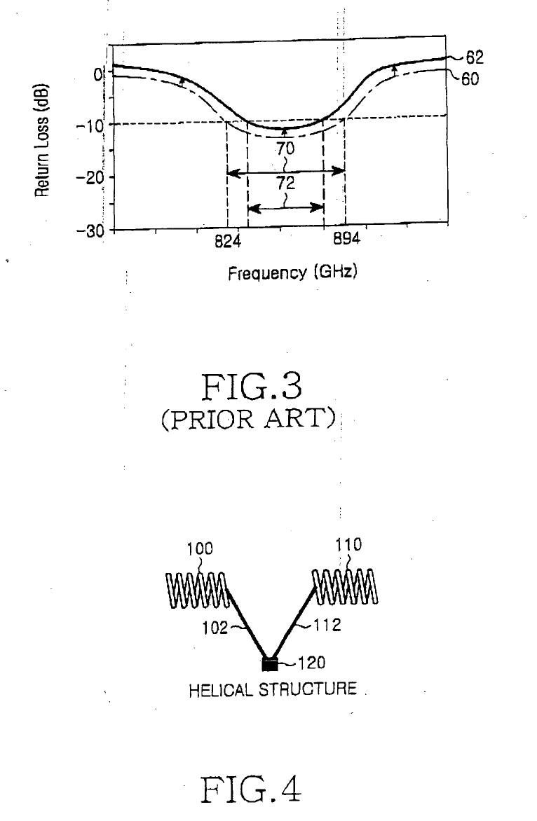

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear.

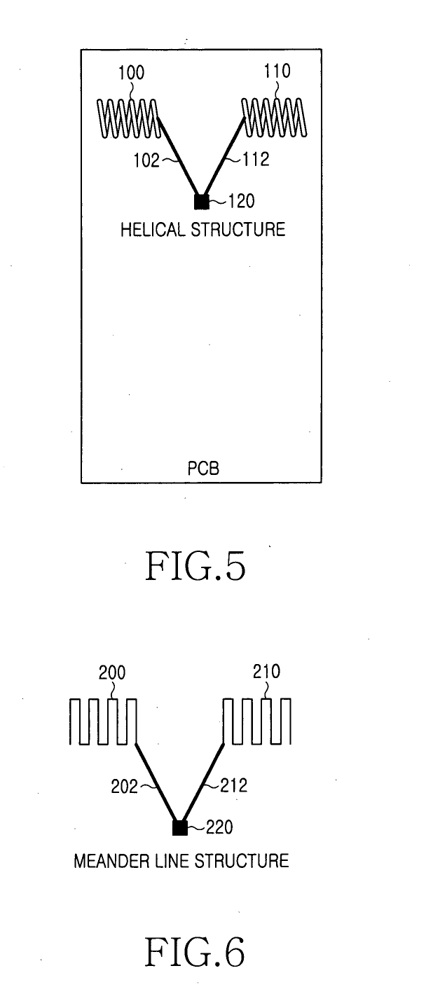

FIG. 4 is a view showing an antenna apparatus according to one embodiment of the present invention. FIG. 5 is a view showing an structure in which the antenna apparatus is incorporated in a cellular phone.

Referring to FIG. 4, the antenna apparatus includes a first helical antenna 100, a second helical antenna 110, a feeding point 120, and two lines 102 and 112. The first helical antenna 100 is connected to the feeding point 120 through the line 102, and the second helical antenna 110 is connected to the feeding point 120 through the line 112. Thus, the first helical antenna 100 and the second helical antenna 110 are dually fed through the feeding point 120.

The helical antennas 100 and 110 have resonance frequencies determined according to their lengths. The first helical antenna 100 and the second helical antenna 110 are designed in such a manner that they have approximately identical resonance characteristics, but the resonance characteristics are somewhat offset from each other. The antenna apparatus according to one embodiment of this structure is incorporated in the cellular phone as shown in FIG. 5. The antenna apparatus may be incorporated by means of a rear side unit (not shown) of the cellular phone or incorporated in a printed circuit board (PCB) by means of a supporting member (not shown).

FIG. 6 is a view showing an antenna apparatus according to another embodiment of the present invention. The antenna apparatus includes a first meander (also know as meander-line) antenna 200, a second meander antenna 210, a feeding point 220, and two lines 202 and 212. The first meander antenna 200 is connected to the feeding point 220 through the line 202, and the second meander antenna 210 is connected to the feeding point 220 through the line 212. Thus, the first meander antenna 200 and the second meander antenna 210 are dually fed through the feeding point 220.

Similarly to the embodiment of the present invention shown in FIG. 5, the first meander antenna 200 and the second meander antenna 210 are designed in such a manner that they have approximately identical resonance characteristics, but the resonance characteristics are somewhat offset from each other. The meander antennas 200 and 210 have resonance frequencies determined according to their lengths.

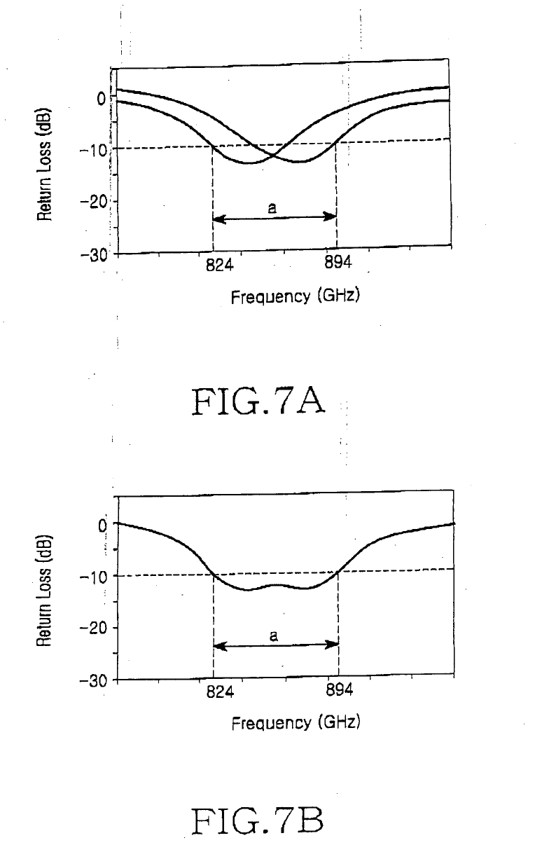

Hereinafter, resonance characteristics of antenna apparatuses according to these embodiments and another embodiment will be described with reference to FIGS. 7A and 7B. FIG. 7A is a graph showing the individual resonance characteristics of two antennas in an antenna apparatus according to the present invention, and FIG. 7B is a graph showing the synthesis of the resonance characteristics of two antennas in the antenna apparatus.

Referring to FIG. 7A, as described above, the two antennas in the antenna apparatus are designed in such a manner that they have approximately identical resonance characteristics, but the resonance characteristics are somewhat offset from each other. That is, a single antenna shows a resonance characteristic which is inferior for the antenna apparatus. Therefore, the present invention proposes a construction having a synthesized resonance characteristics of two antennas, thereby ensuring a sufficiently wide bandwidth. Accordingly, the two antennas in the antenna apparatus are designed in such a manner that they have approximately identical resonance characteristics, but two frequency resonance characteristics are somewhat offset from each other as shown in FIG. 7A. Since a helical antenna and a meander antenna have different resonance characteristics according to their lengths, two antennas are designed in such a manner that they have different lengths, to provide the offset resonance characteristics. Accordingly, as shown in FIG. 7B, a bandwidth proper for stable operation of an antenna in a cellular phone is obtained by synthesizing resonance characteristics of two antennas. In other words, a bandwidth above the range indicated by reference numeral ‘a’ is obtained under return loss of −10 dB.

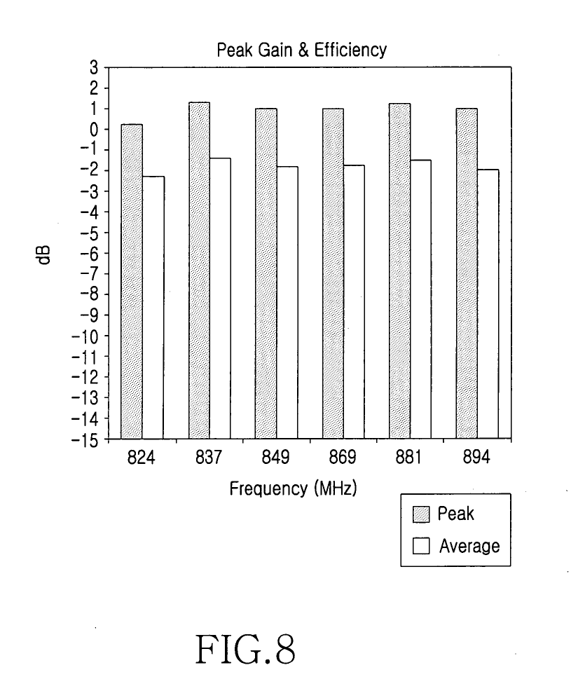

The performance of such an antenna apparatus according to one embodiment of the present invention is represented through a graph shown in FIG. 8. Efficiency and a peak gain corresponding to each resonant frequency in antenna apparatuses according to embodiments of the present invention are shown. The maximum peak gain 1.3 dBi, the average peak value −1.8 dBi, and the efficiency 66% show the superior antenna efficiency and the superior antenna gain.

As described above, according to the present invention, it is possible to easily obtain antenna performance required for the entire wide frequency band by incorporating and dually feeding antennas having different frequency resonance characteristics.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. An antenna apparatus comprising:
a plurality of antennas having different resonance frequency characteristics;
a feeding point connected to the plurality of antennas and used for feeding; and
lines for connecting the plurality of antennas to the feeding point.

2. The antenna apparatus as claimed in claim 1, wherein the plurality of antennas include helical antennas.

3. The antenna apparatus as claimed in claim 1, wherein the plurality of antennas include meander antennas.

4. The antenna apparatus as claimed in claim 1, wherein the plurality of antennas have different lengths.

5. The antenna apparatus as claimed in claim 2, wherein the helical antennas have different lengths.

6. The antenna apparatus as claimed in claim 3, wherein the meander antennas have different lengths.
